(19) United States
(12) Patent Application Publication
(10) Pub. No.: US 2024/0217384 A1
(43) Pub. Date: Jul. 4, 2024

(54) METHOD AND SYSTEM FOR CONTROLLING ELECTRIC VEHICLE CHARGING

(71) Applicant: HYUNDAI AUTOEVER CORP., Seoul (KR)

(72) Inventors: Lam Lee, Seoul (KR); Eun Sue Kim, Seoul (KR)

(73) Assignee: HYUNDAI AUTOEVER CORP., Seoul (KR)

(21) Appl. No.: 18/397,282

(22) Filed: Dec. 27, 2023

(30) Foreign Application Priority Data
Dec. 30, 2022 (KR) 10-2022-0191085

(51) Int. Cl. B60L 58/10; B60L 58/12; B60L 58/16

(52) U.S. Cl. CPC B60L 58/10; B60L 58/12; B60L 58/16; B60L 53/305

(57) ABSTRACT

A charging control method and system. The method includes receiving driving information of an electric vehicle, monitoring a state of a battery within the electric vehicle, determining the electric vehicle's feasibility of driving to a final destination, and when it is determined that the electric vehicle is not feasible to drive to the final destination, recommending a charging amount for the battery using the received driving information and the monitored state of the battery.

### CROSS-REFERENCE TO RELATED APPLICATION

This application claims the benefit of and priority to Korean Patent Application No. 10-2022-0191085 filed on Dec. 30, 2022, the entire contents of which are incorporated herein by reference.

### FIELD

The present disclosure relates to a method of controlling electric vehicle charging, and more particularly, to a method of recommending a charging amount reflecting the state information of a battery within an electric vehicle.

### BACKGROUND

The statements in this section merely provide background information related to the present disclosure and may not constitute prior art.

When charging an electric vehicle, it is common to determine the charging amount considering only the current State of Charge (SoC) level of the battery of the electric vehicle. Therefore, overcharging often occurs, ignoring variables related to the battery itself, apart from the voltage stored in the battery.

Since electric vehicles are characterized by a constant flow of current, there is a risk that applying a voltage exceeding the current allowable level to an aged battery may easily lead to secondary accidents, such as fires.

Furthermore, a charging behavior that consistently overcharges the battery of an electric vehicle may accelerate the aging of the battery, which may lead to a reduction in the driving range of the electric vehicle. Conversely, charging too little or always the same amount of charge, regardless of the destination, may also consume unnecessary resources (e.g., increased estimated arrival time).

### SUMMARY

An aspect of the present disclosure provides a method and system for monitoring the state and performance of a battery within an electric vehicle.

Another aspect of the present disclosure provides a method and system for determining the feasibility of driving to the final destination of an electric vehicle, based on driving information and battery state information obtained from the electric vehicle.

Another aspect of the present disclosure provides a method and system for offering a recommended charging amount for a battery within an electric vehicle, which allows for driving to the final destination of an electric vehicle, reflecting the monitored state of the battery.

However, aspects of the present disclosure are not limited to those set forth herein. The above and other aspects of the present disclosure should be apparent to one of ordinary skill in the art to which the present disclosure pertains by referencing the detailed description of the present disclosure given below and the accompanying drawings.

According to an embodiment of the present disclosure, a charging control method performed by a charging control system is provided. The method may include: receiving driving information of an electric vehicle; monitoring a state of a battery within the electric vehicle; determining the electric vehicle's feasibility of driving to a final destination; and if it is determined that the electric vehicle is not feasible to drive to the final destination, recommending a charging amount for the battery using the received driving information and the monitored state of the battery.

In some aspects of the present disclosure, receiving the driving information may include receiving at least one of charging scheduling data of the electric vehicle, driving pattern data of the electric vehicle, final destination data of the electric vehicle, or data detected by external sensors of the electric vehicle.

In some aspects of the present disclosure, monitoring the state of the battery may include determining a State of Health (SoH), State of Life (SoL), State of Balance (SoB), and State of Safety (SoS) of the battery.

In some aspects of the present disclosure, determining the SoH of the battery may include determining a rate of decrease of a chargeable capacity of the battery using the charging scheduling data of the electric vehicle.

In some aspects of the present disclosure, determining the SoH of the battery may include determining a rate of decrease of a chargeable capacity of the battery using temperature/impact data detected by external sensors of the electric vehicle.

In some aspects of the present disclosure, determining the SOL of the battery may include calculating a cycle where a chargeable capacity of the battery is reduced below a minimum standard SoC level, using a rate of decrease of the chargeable capacity of the battery.

In some aspects of the present disclosure, determining the SoB of the battery may include: if the battery is a battery pack including a plurality of individual cells, calculating differences between state indicators of the individual cells within the battery pack.

In some aspects of the present disclosure, determining the SoS of the battery includes classifying the SoS of the battery into grades, and the grades may include good, caution, and danger grades.

In some aspects of the present disclosure, classifying the SoS of the battery may include outputting a warning message to a communication controller of the electric vehicle if the SoS of the battery is classified as the caution grade.

In some aspects of the present disclosure, classifying the SoS of the battery may include limiting the driving of the electric vehicle if the SoS of the battery is classified as the danger grade.

In some aspects of the present disclosure, determining the electric vehicle's feasibility of driving to the final destination may include calculating the electric vehicle's drivable distance based on the monitored state of the battery and determining the electric vehicle's feasibility of driving to the final destination based on the calculated drivable distance.

In some aspects of the present disclosure, calculating the electric vehicle's drivable may include updating state information of the battery using the electric vehicle's driving pattern and calculating the electric vehicle's drivable distance using the updated state information of the battery.

In some aspects of the present disclosure, recommending the charging amount for the battery may include displaying locations of charging stations that may be stopped at between a current location of the electric vehicle and the final destination.

In some aspects of the present disclosure, the method may further include acquiring a machine learning model that has learned the monitored state of the battery and determining a charging amount to be recommended for the battery using the machine learning model.

According to another embodiment of the present disclosure, a charging control apparatus is provided. The apparatus may include at least one processor, a network interface receiving data regarding a battery, included in a charging request signal from an electric vehicle, a memory storing the received data, a data collection unit receiving driving information of the electric vehicle, a monitoring unit monitoring a state of the battery within the electric vehicle, a determination unit determining the electric vehicle's feasibility of driving to a final destination, and a control unit recommending a charging amount for the battery using the received driving information and the monitored state of the battery if it is determined that the electric vehicle is not feasible to drive to the final destination.

In some aspects of the present disclosure, the driving information may include at least one of charging scheduling data of the electric vehicle, driving pattern data of the electric vehicle, final destination data of the electric vehicle, or data detected by external sensors of the electric vehicle.

In some aspects of the present disclosure, the monitoring unit may determine a State of Health (SoH), State of Life (SoL), State of Balance (SoB), and State of Safety (SoS) of the battery.

According to yet another embodiment of the present disclosure, a charging control system is provided. The system may include a network interface receiving monitoring information regarding a battery within an electric vehicle, a memory loading a charging amount recommendation program using the monitoring information regarding the battery, and at least one processor executing the charging amount recommendation program. The charging amount recommendation program includes instructions for receiving driving information of the electric vehicle, instructions for monitoring a state of the battery within the electric vehicle, instructions for determining the electric vehicle's feasibility of driving to a final destination, and instructions for recommending a charging amount for the battery using the received driving information and the monitored state of the battery if it is determined that the electric vehicle is not feasible to drive to the final destination.

In some aspects of the present disclosure, the instructions for receiving the driving information may include instructions for receiving at least one of charging scheduling data of the electric vehicle, driving pattern data of the electric vehicle, final destination data of the electric vehicle, and data detected by external sensors of the electric vehicle.

In some aspects of the present disclosure, the instructions for monitoring the state of the battery may include instructions for determining a State of Health (SoH), State of Life (SoL), State of Balance (SoB), and State of Safety (SoS) of the battery.

It should be noted that the effects of the present disclosure are not limited to those described above, and other effects of the present disclosure should be apparent from the following description.

### BRIEF DESCRIPTION OF THE DRAWINGS

The above and other aspects and features of the present disclosure should be more apparent by describing in detail embodiments thereof with reference to the attached drawings.

FIG. 1 depicts a diagram illustrating an environment to which a method of controlling electric vehicle charging according to an embodiment of the present disclosure is applicable.

FIG. 2 depicts a block diagram illustrating an apparatus for controlling electric vehicle charging according to an embodiment of the present disclosure.

FIG. 3 depicts a block diagram illustrating driving information, acquired according to some embodiments of the present disclosure, of an electric vehicle.

FIG. 4 depicts a diagram illustrating state information of a battery equipped in an electric vehicle monitored according to some embodiments of the present disclosure.

FIG. 5 depicts a flowchart illustrating a method of controlling electric vehicle charging according to an embodiment of the present disclosure.

FIGS. 6 through 9 depict detailed flowcharts illustrating some steps of the method of FIG. 5.

FIG. 10 depicts a block diagram illustrating a machine learning model outputting a recommended charging amount in accordance with battery state information input according to some embodiments of the present disclosure.

FIGS. 11A, 11B, and 12 depict diagrams illustrating state information of a battery according to some embodiments of the present disclosure.

FIG. 13 depicts diagram illustrating a screen where a charging amount and charging stations recommended according to some embodiments of the present disclosure are displayed.

FIG. 14 depicts a hardware configuration view illustrating a computing system according to some embodiments of the present disclosure.

### DETAILED DESCRIPTION

Hereinafter, embodiments of the present disclosure are described with reference to the accompanying drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure is thorough and complete and fully conveys the concept of the disclosure to those having ordinary skill in the art, and the present disclosure is defined by the claims.

In describing the present disclosure, when it is determined that the detailed description of the related well-known configuration or function may obscure the gist of the present disclosure, the detailed description thereof is omitted.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component. When a component, device, element, or the like of the present disclosure is described as having a purpose or performing an operation, function, or the like, the component, device, or element should be considered herein as being “configured to” meet that purpose or to perform that operation or function.

Hereinafter, embodiments of the present disclosure are described with reference to the accompanying drawings.

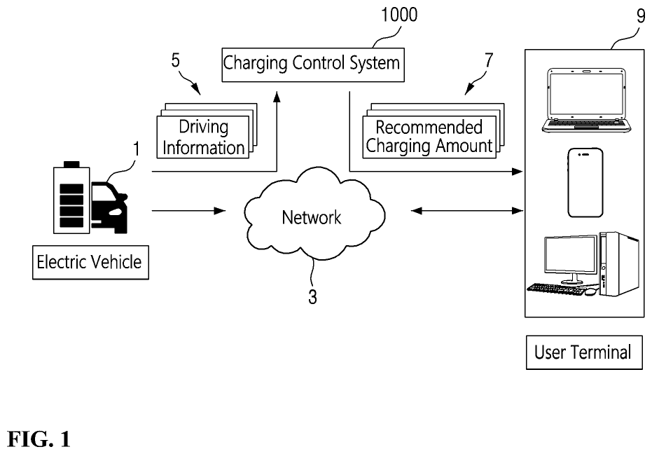

Before explaining a method of controlling electric vehicle charging according to an embodiment of the present disclosure, the environment to which some embodiments of the present disclosure may be applied is hereinafter described with reference to FIG. 1.

Referring to FIG. 1, a charging control system 1000 may receive driving information 5 from an electric vehicle 1 through a network 3. Additionally, the charging control system 1000 may display a recommended charging amount 7 for a battery within the electric vehicle 1 on a user terminal 9, which is associated with the electric vehicle 1, using the driving information 5.

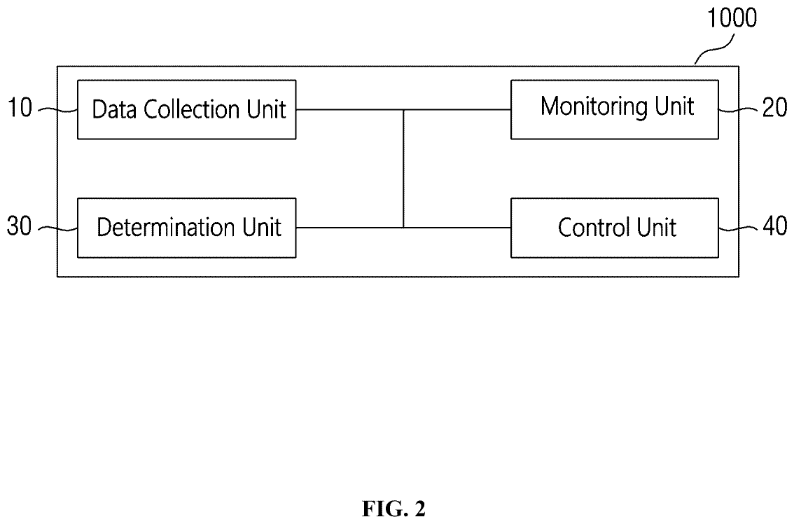

The charging control system 1000 may be understood as being an entity performing a method of controlling electric vehicle charging according to an embodiment of the present disclosure, and may also be understood as being an apparatus for controlling electric vehicle charging according to an embodiment of the present disclosure. A detailed description of the charging control system 1000 is presented later with reference to FIG. 2. For the convenience of explanation, the charging control system 1000 is described as being a unified entity combined with a computing device.

Referring again to FIG. 1, the charging control system 1000 may perform a process of calculating the battery capacity necessary for the electric vehicle 1 to drive to a set destination.

For example, the charging control system 1000 may use the distance to a final destination set by the electric vehicle 1 and the charging history of the electric vehicle 1 to calculate the battery capacity necessary for the electric vehicle 1 to drive to the set final destination.

Furthermore, the charging control system 1000 may calculate the necessary charging amount for the battery by conducting the method of controlling electric vehicle charging according to an embodiment of the present disclosure using the driving information 5, received from the electric vehicle 1, to further reflect the state of the battery.

Conventionally, only the current State of Charge (SoC) of the battery may be considered to calculate the necessary charging amount for the battery. As a result, the reduced capacity of the battery due to continuous aging and degradation cannot be accounted for, potentially leading to the application of voltages that the aged battery cannot handle, and thus causing a major accident.

On the other hand, the charging control system 1000 may solve this problem by using the driving information 5 to additionally reflect indicators related to the current state and performance of the battery, and thus recommend an appropriate charging amount based on the state of the battery.

Specifically, the charging control system 1000 may calculate the chargeable capacity of an aged battery by reflecting indicators related to the current state and performance of the battery, such as the State of Health (SoH), State of Life (SoL), State of Balance (SoB), and State of Safety (SoS) of the battery.

Subsequently, the charging control system 1000 may display a calculated recommended charging amount for the battery on the user terminal 9. That is, the charging control system 1000 may recommend, to the driver who intends to charge the electric vehicle 1, the amount of charge needed for traveling to a destination, as well as the permissible charging amount for the battery.

Additionally, the charging control system 1000 may display recommended charging station candidates based on the calculated recommended charging amount for the battery on the user terminal 9.

The user terminal 9, where the recommended charging amount or the recommended charging station candidates are displayed, may be implemented as an in-vehicle Center Information Display (CID), a Head Up Display (HUD), a personal or in-vehicle terminal, or a display device capable of enabling user input or pad manipulations, but the present disclosure is not limited thereto.

The environment to which the method of controlling electric vehicle charging according to an embodiment of the present disclosure may be applied has been described so far with reference to FIG. 1. The configuration of an apparatus that may implement the method of controlling electric vehicle charging according to an embodiment of the present disclosure is hereinafter described with reference to FIG. 2.

FIG. 2 depicts a block diagram illustrating an apparatus for controlling electric vehicle charging according to an embodiment of the present disclosure. In the description that follows, the apparatus of FIG. 2, which is an object to which the method of controlling electric vehicle charging according to an embodiment of the present disclosure is applied, is treated the same as the charging control system 1000 of FIG. 1 for the convenience of explanation.

Referring to FIG. 2, the apparatus 1000 may include a data collection unit 100, which acquires driving information of an electric vehicle to be charged, and a monitoring unit 200, which monitors the state of a battery equipped in the electric vehicle.

The apparatus 1000 may further include a determination unit 300, which determines the feasibility of driving to a predetermined final destination of the electric vehicle, and a control unit 400, which recommends an appropriate charging amount for the battery if it is determined that the electric vehicle cannot drive to the final destination with the current charge held by the battery, using the driving information and battery state information.

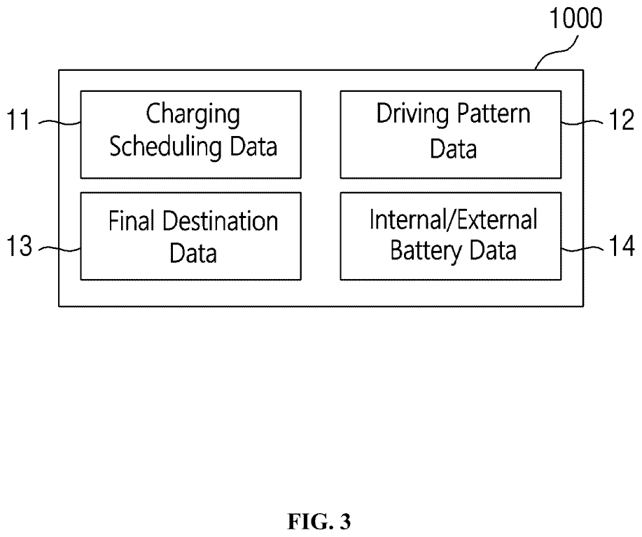

First, the data collection unit 100 of the apparatus 1000 may acquire at least one driving information from among charging scheduling data of the electric vehicle, driving pattern data of the electric vehicle, final destination data of the electric vehicle, and data detected by external sensors of the electric vehicle. This is described later in further detail with reference to FIG. 3.

In an embodiment, the apparatus 1000 may analyze the driver's charging pattern and driving pattern for the same destination, obtained by the data collection unit 100, and calculate and recommend a charging amount to be charged to the battery, based on the current state of the battery.

Also, in an embodiment, the charging control apparatus 1000 may also calculate and recommend an appropriate charging amount for the battery based on state information of the battery that may vary depending on external temperature or impacts, obtained by the data collection unit 100.

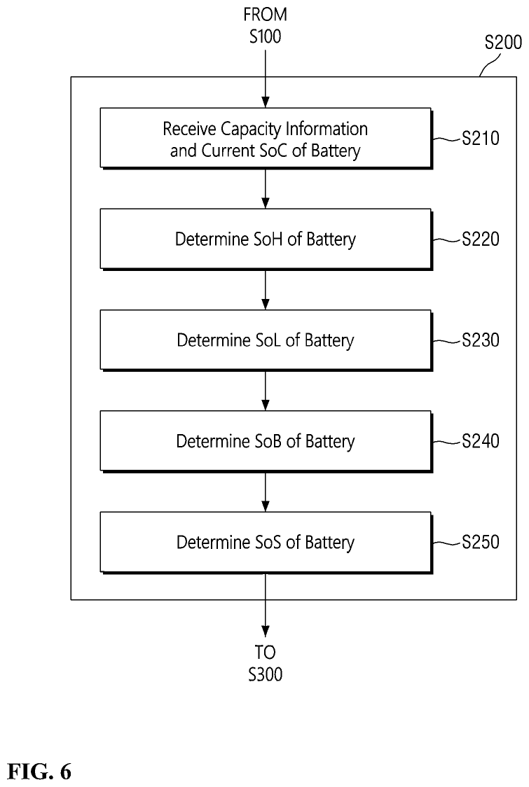

The monitoring unit 200 of the apparatus 1000 may determine the state or performance of the battery, such as the SoC, SoH, SOL, SoB, and SoS of the battery. This is described later in further detail with reference to FIG. 6.

Additionally, the monitoring unit 200 of the apparatus 1000 may set different monitoring periods for different state indicators for the battery. For example, the monitoring unit 200 may monitor the SoS and SoB of the battery in real time and periodically monitor the SoH of the battery and the driver's charging pattern. However, the present disclosure is not limited to this example.

In an embodiment, the apparatus 1000 may determine that the SoH or SoS of the battery has reached a serious level based on the state of the battery determined by the monitoring unit 200. Then, the apparatus 1000 may display a warning message for the driving of the electric vehicle and a message limiting driving on the user terminal of the electric vehicle.

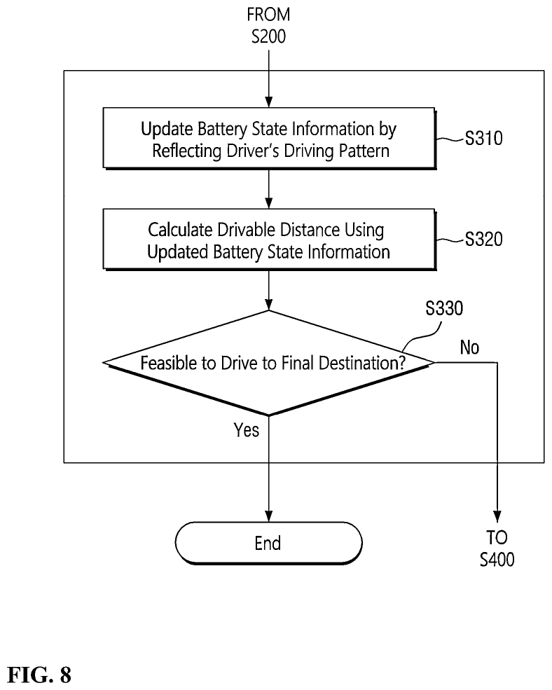

Additionally, the determination unit 300 of the apparatus 1000 may calculate the drivable distance of the electric vehicle using state information of the battery. Then, the determination unit 300 may determine the electric vehicle's feasibility of driving to the predetermined destination based on the calculated drivable distance. This is described later in further detail with reference to FIG. 8.

In an embodiment, the determination unit 300 of the apparatus 1000 may update and utilize the state information of the battery by reflecting the driver's driving pattern in the received driving information during the calculation of the electric vehicle's drivable distance based on the results of the monitoring of the battery.

Furthermore, if it is determined that the electric vehicle is not feasible to drive to the predetermined destination based on the calculated drivable distance, the control unit 400 of the apparatus 1000 may calculate an additional charging amount to be charged to the battery and display the calculated additional charging amount on the user terminal of the electric vehicle.

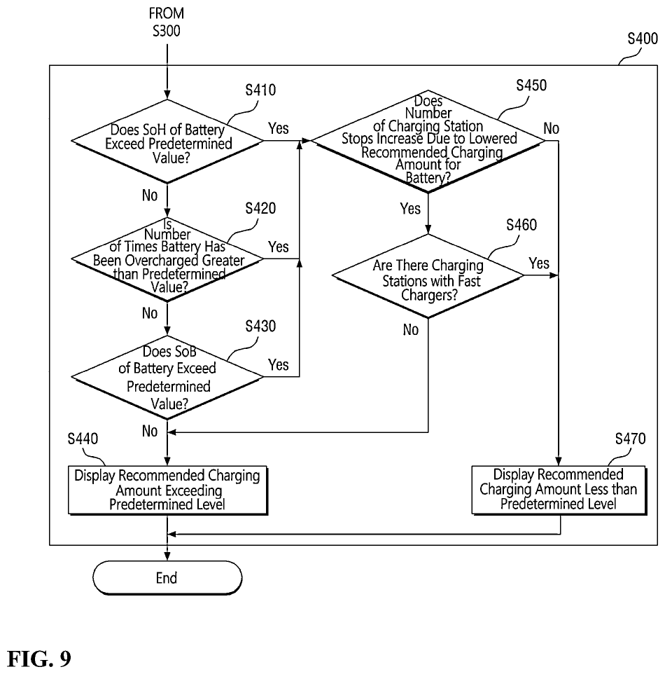

In an embodiment, if it is determined that the electric vehicle is not feasible to drive based on the calculated drivable distance, the control unit 400 of the apparatus 1000 may display information on charging stations present between the electric vehicle and the predetermined destination on the user terminal of the electric vehicle. This is described later in further detail with reference to FIG. 9.

The configuration of the apparatus for controlling electric vehicle charging according to an embodiment of the present disclosure has been described so far with reference to FIG. 2. Driving information received from an electric vehicle is hereinafter described with reference to FIG. 3.

FIG. 3 depicts a block diagram illustrating driving information, acquired according to some embodiments of the present disclosure, of an electric vehicle.

Referring to FIG. 3, the driving information acquired by the charging control system 1000 may include, for example, electric vehicle charging scheduling data 11, driving pattern data 12, and final destination data 13 of an electric vehicle.

In an embodiment, the charging control system 1000 may acquire the charging scheduling data 11 to determine the charging pattern of the driver of the electric vehicle. As a result, the charging control system 1000 may predict a charging amount currently being intended to be charged, based on the capacity, and the charging intervals of the battery in the past. Consequently, the charging control system 1000 may present differentiated recommended charging amounts by reflecting not only the battery's state information but also the driver's charging pattern.

Additionally, in an embodiment, the charging control system 1000 may acquire the driving pattern data 12 to determine the state of the battery according to the driving behavior of the driver. For example, the charging control system 1000 may determine the extent of the impact on the battery by recognizing the electric vehicle's driving time or driving control operations.

Furthermore, in an embodiment, the charging control system 1000 may acquire the final destination data 13 to calculate the distance from the electric vehicle's current location to the electric vehicle's final destination. As a result, the charging control system 1000 may determine the amount of battery charge that is expected to be consumed to reach the final destination.

Moreover, the driving information acquired by the charging control system 1000 may include internal/external battery data 14. For example, the system 100 may acquire the internal/external battery data 14 to determine the state of the battery.

For example, the charging control system 1000 may acquire external temperature/impact data from external sensors such as motion detection sensors installed in the electric vehicle. Consequently, the charging control system 1000 may determine the state of the battery that may be affected by external environmental factors.

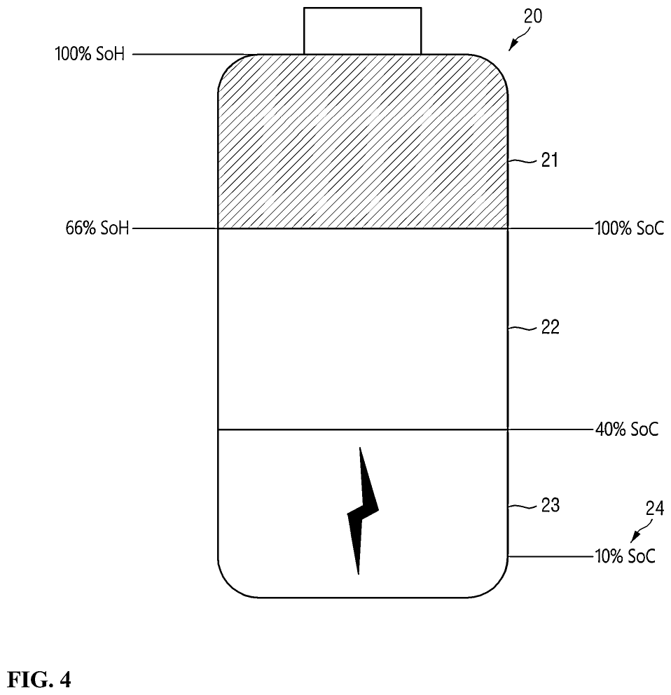

Driving information of an electric vehicle that may be used in the method of controlling electric vehicle charging according to an embodiment of the present disclosure has been described so far with reference to FIG. 3. Indicators that may represent the state of a battery within an electric vehicle according to some embodiments of the present disclosure is hereinafter described with reference to FIG. 4.

FIG. 4 depicts a diagram illustrating state information of a battery within an electric vehicle, monitored according to some embodiments of the present disclosure. Referring to FIG. 4, the charging control system 1000 may monitor the state of a battery 20 within an electric vehicle.

In some embodiments, the charging control system 1000 monitoring the state of the battery 20 may be implemented to interwork with a Battery Management System (BMS), but the present disclosure is not limited thereto.

The battery 20 may include a single battery cell or a plurality of battery cells. For the convenience of explanation, the battery 20 is hereinafter described as including, for example, a single battery cell.

Referring again to FIG. 4, the battery 20 may include an area 21 that is no longer chargeable due to aging, an area 23 that is currently charged, and an area 22 that is currently chargeable.

When the battery 20 is yet to age, the charging control system 1000 may measure the SoH of the battery 20 as 100%.

Then, as the battery 20 ages due to continued charging or discharging cycles, the usable capacity of the battery 20 decreases. For example, the charging control system 1000 may measure the SoH of the battery 20 with a reduced capacity by as much as the size of the area 21 from its original total capacity as 66%. In other words, the charging control system 1000 may determine the rate of decrease in the usable capacity of the battery 20.

The charging control system 1000 may measure the SoC level for the reduced usable capacity of the battery 20 as 100%. Then, as illustrated in FIG. 4, the charging control system 1000 may measure the SoC level for the remaining charge in the battery 20 as 40%.

Furthermore, in an embodiment, the charging control system 1000 may measure a minimum standard SoC level 24 of the battery 20 as 10%. The minimum standard SoC level 24 may be understood as the minimum amount of battery charge necessary to maintain the functions of the electric vehicle.

Additionally, in an embodiment, the charging control system 1000 may calculate the SOL of the battery 20 using the rate of decrease in the usable capacity of the battery 20 and the minimum standard SoC level 24 of the battery 20.

Specifically, the charging control system 1000 may use the rate of decrease in the usable capacity of the battery 20 to calculate the cycle in which the chargeable area 22 of the battery 20 decreases below the minimum standard SoC level 24 as the SOL of the battery 20. Furthermore, in an embodiment, the charging control system 1000 may determine the SoL of the battery 20, which varies depending on the charging frequency of the battery 20, by analyzing the charging pattern of the battery 20.

Temperature data detected by the external sensors of the electric vehicle may be used to calculate the SOL of the battery 20. For example, if the number of times the battery 20 is charged or the parking duration of the electric vehicle at very low external temperature exceeds a predetermined threshold, a penalty may be applied to the SOL of the battery 20 and may thus be reflected in charging amount recommendation logic.

Additionally, in an embodiment, if the battery 20 is a battery pack including a plurality of cells, the SoB of the battery 20 may be calculated by comparing the state indicators (e.g., SoC, temperature, voltage, etc.) of the individual cells within the battery pack within the battery pack. The higher the SoB of the battery 20, the lower the performance of the battery 20, and the lower the charging efficiency of the battery 20. Accordingly, the charging control system 1000 may determine whether the aging of the battery 20 is accelerating based on the SoB of the battery 20. This is described later in further detail with reference to FIG. 6.

In an embodiment, the charging control system 1000 may measure the SoS of the battery 20. For example, the charging control system 1000 may measure the SoS of the battery 20 based on the aforementioned state indicators of the battery 20.

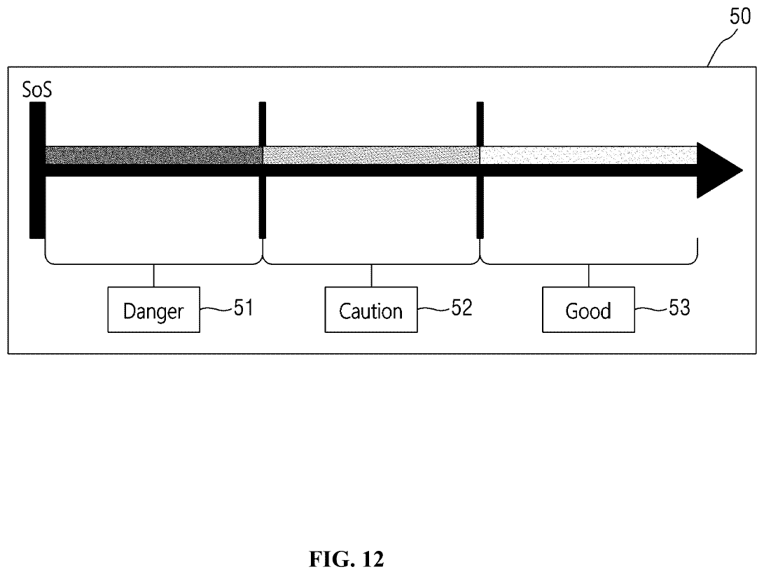

The charging control system 1000 may classify the SoS of the battery 20 into different grades. For example, the charging control system 1000 may classify the SoS of the battery 20 into a good, caution, or danger grade. Additionally, the charging control system 1000 may implement different control methods depending on the SoS of the battery 20. This is described later in further detail with reference to FIG. 12.

Consequently, the charging control system 1000 may reflect the state and performance of the battery 20 by monitoring the battery 20 to recommend an appropriate charging amount for the battery 20.

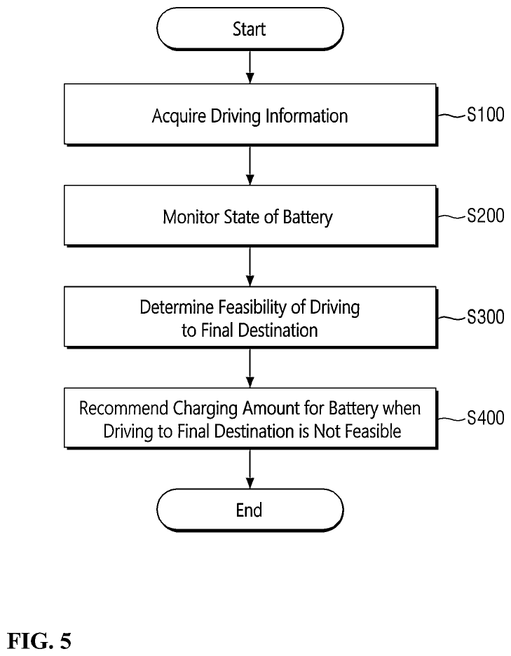

Various state information of a battery within an electric vehicle, monitored according to some embodiments of the present disclosure, has been described so far with reference to FIG. 4. The method of controlling electric vehicle charging according to an embodiment of the present disclosure is described with reference to FIGS. 5 through 9.

FIG. 5 depicts a flowchart illustrating the method of controlling electric vehicle charging according to an embodiment of the present disclosure.

Referring to FIG. 5, the charging control system 1000 may acquire driving information of an electric vehicle (S100). As described above with reference to FIG. 3, the charging control system 1000 may acquire at least one data from among charging scheduling data of the electric vehicle, driving pattern data of the electric vehicle, final destination data of the electric vehicle, and data detected by external sensors of the electric vehicle.

For example, the final destination data may include information on the distance and time required to reach the final destination of the electric vehicle or the locations of charging stations along the route to the final destination.

The data detected by the external sensors of the electric vehicle may include information on the external temperature and the extent of damage to the electric vehicle caused by external impacts.

Thereafter, the charging control system 1000 may monitor the state of the battery within the electric vehicle (S200). Specifically, the charging control system 1000 may acquire data regarding the SoC of the battery and may determine the state and performance of the battery using a plurality of data included in the driving information acquired in step S100.

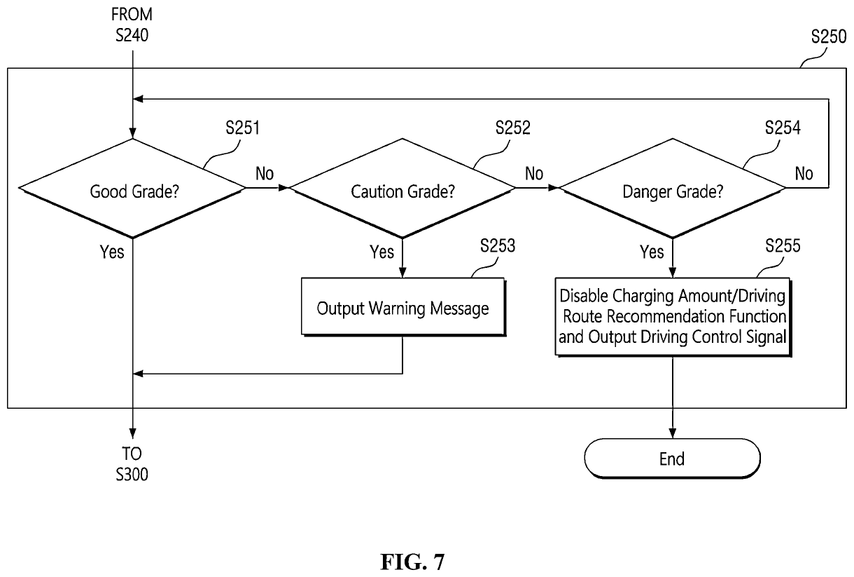

States of the battery that may be determined by the charging control system 1000 include, for example, the SoH, SOL, SoB, and SoS of the battery, but the present disclosure is not limited thereto. This is described later in further detail with reference to FIGS. 6 and 7.

Thereafter, the charging control system 1000 may determine the feasibility of driving to the final destination of the electric vehicle (S300). First, the charging control system 1000 may determine the distance between the current location of the electric vehicle and the final destination.

Thereafter, the charging control system 1000 may calculate the expected consumption of the battery based on the results of the monitoring of the current state of the battery and the distance to the final destination. As a result, the charging control system 1000 may determine the electric vehicle's feasibility of driving to its final destination with the remaining charge of the battery. This is described later in further detail with reference to FIG. 8.

If the charging control system 1000 determines, based on the state information of the battery, that it is feasible for the electric vehicle to drive to the final destination, then the electric vehicle may be allowed to drive to the final destination using the remaining charge of the battery.

Conversely, if the charging control system 1000 determines that it is not possible for the electric vehicle to drive to the final destination, the charging control system 1000 may recommend an appropriate charging amount for the battery within the electric vehicle (S400).

The charging control system 1000 may recommend charging stations where the recommended charging amount may be charged, using the acquired driving information of the vehicle and the state information of the battery. This is described later in further detail with reference to FIG. 9.

The method of controlling electric vehicle charging according to an embodiment of the present disclosure has been described so far with reference to FIG. 5. Some steps of the method of controlling electric vehicle charging according to an embodiment of the present disclosure is hereinafter described with reference to FIGS. 6 through 9.

FIG. 6 depicts a detailed flowchart illustrating the step of monitoring the state of the battery, as performed in the method of FIG. 4.

Referring to FIG. 6, the charging control system 1000 may receive information on the total capacity and the current SoC level of the battery (S210). Thereafter, the charging control system 1000 may determine and monitor the state and performance information of the battery using the driving information of the electric vehicle, acquired in step S100.

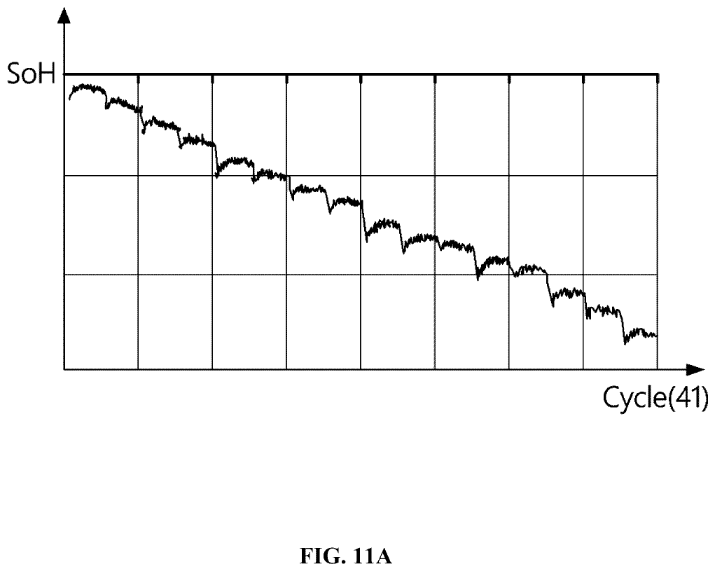

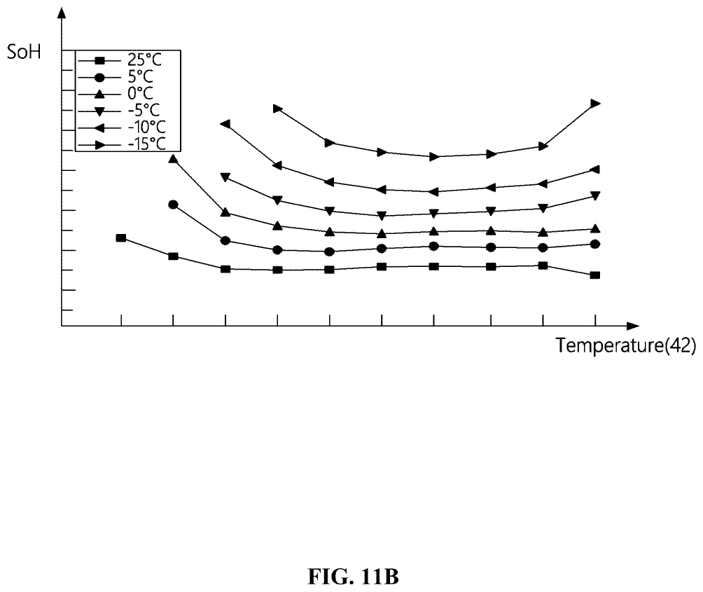

First, the charging control system 1000 may determine the SoH of the battery within the electric vehicle using the charging scheduling data of the electric vehicle (S220). For example, the charging control system 1000 may acquire the charging history of the electric vehicle and may determine the degree to which the chargeable capacity of the battery has decreased due to aging, degradation, or increases in charging/discharging cycles. This is described later in further detail with reference to FIG. 11A.

Additionally, the charging control system 1000 may identify the decrease in the chargeable capacity of the battery using external temperature/impact data detected by external sensors of the electric vehicle.

For example, if the charging control system 1000 detects that the external temperature is low through the external sensors of the electric vehicle, the charging control system 1000 may identify that the chargeable capacity of the battery is decreasing due to an increase in the internal resistance of the battery. Conversely, the charging control system 1000 may also identify such decrease in the battery's chargeable capacity even when the electric vehicle is continuously exposed to high temperature. This is described later in further detail with reference to FIG. 11B.

Additionally, in an embodiment, the charging control system 1000 may analyze the most frequently charged amounts from the charging history of the electric vehicle to determine the driver's charging habits and preferences. As a result, the charging control system 1000 may provide a recommended charging amount for the battery not only using the results of monitoring the state and performance of the battery but also the driver's charging patterns and preferences.

That is, the charging control system 1000 may determine the SoH of the battery based on the rate at which the chargeable capacity of the battery decreases as compared to any influencing factors. In this case, the charging control system 1000 may measure the decrease in the chargeable capacity of the battery in proportion to factors affecting the SoH of the battery. However, the present disclosure is not limited to this.

Furthermore, the charging control system 1000 may determine the SOL of the battery using the rate of decrease in the chargeable capacity of the battery (S230).

Specifically, as described above with reference to FIG. 5, the charging control system 1000 may additionally receive the minimum standard SoC level of the battery while acquiring the driving information of the electric vehicle in step S100.

As a result, when determining the SOL of the battery, the charging control system 1000 may identify the point where the chargeable capacity of the battery decreases below the minimum standard SoC level and may express the identified point as the number of charging/discharging cycles or as a period, but the present disclosure is not limited thereto.

Consequently, by monitoring the SOL of the battery, the charging control system 1000 may pre-emptively determine when to replace the battery and may thereby reduce the risk of accidents.

Additionally, in an embodiment, if the battery includes a battery pack of multiple cells, the driver's charging pattern may cause overcharging or over-discharging of the battery cells, leading to voltage imbalance among the multiple cells. Therefore, the charging control system 1000 may determine the SoB for the battery cells (S240) and thereby identify that the performance of the overcharged or over-discharged battery cells has deteriorated, leading to a reduction in the chargeable capacity of the battery cells.

Furthermore, the charging control system 1000 may determine the SoS of the battery in consideration of a comprehensive range of indicators for the state and the performance of the battery, such as the SoH, SOL, and SoB of the battery (S250).

The charging control system 1000 may classify the SoS of the battery into different grades such as, for example, good, caution, and danger grades, but the present disclosure is not limited thereto.

Therefore, the charging control system 1000 may determine the SoS of the battery as one of the good, caution, and danger grades based on the driving information of the electric vehicle and the state and performance indicators of the battery. This is described later in further detail with reference to FIG. 7.

FIG. 7 is a detailed flowchart illustrating the step of determining the SoS of the battery using the driving information of the electric vehicle and the state and performance indicators of the battery, as performed in the method of FIG. 6.

Referring to FIG. 7, the charging control system 1000 may select at least one battery state information, including the current SoC level of the battery, as a criterion for classifying the SoS of the battery.

Thereafter, the charging control system 1000 may classify the SoS of the battery based on at least one battery state information. For example, the charging control system 1000 may determine the SoS of the battery based on a plurality of battery state information such as the SoC, SoH, and SoB of the battery. In this case, the charging control system 1000 may set different weights for different battery state information and may classify the SoS of the battery.

The charging control system 1000 may determine the SoS of the battery based on at least one of the plurality of battery state information (S251, S252, and S254).

If the SoS of the battery is classified as the good grade based on a particular criterion (S251), the charging control system 1000 may determine the feasibility of driving to the final destination based on the SoC and other state information of the battery (S300). Step S300 is described later in further detail with reference to FIG. 8.

On the other hand, if the SoS of the battery is classified as the caution grade based on a particular criterion (S252), the charging control system 1000 may output a warning or caution message regarding the battery's state on the user terminal of the electric vehicle (S253).

Additionally, if the SoS of the battery is classified as the danger grade (S254), the charging control system 1000 may disable a charging amount/charging station recommendation function to prevent the display of a recommended charging amount on the user terminal of the electric vehicle (S255).

In an embodiment, the charging control system 1000 may output a driving control signal to completely control the driving of the electric vehicle. The driving control signal output by the charging control system 1000 may include, for example, a signal to prevent the recommendation of a charging amount for the battery and a signal to block the operation of control devices such as brakes or accelerator to completely limit the driving of the electric vehicle, but the present disclosure is not limited thereto.

If the SoS of the battery is classified into none of the good, caution, and danger grades, the method returns to S251 so that the charging control system 1000 may determine the SoS of the battery again based on at least one of the plurality of battery state information.

FIG. 8 depicts a detailed flowchart illustrating the step of determining the feasibility of driving to the final destination of the electric vehicle, as performed in the method of FIG. 5.

Referring to FIG. 8, in an embodiment, the charging control system 1000 may update the battery state information by reflecting the previously acquired driving pattern of the driver (S310). Thereafter, the charging control system 1000 may calculate the drivable distance of the electric vehicle based on the updated battery state information (S320).

As a result, the charging control system 1000 may calculate the drivable range of the electric vehicle by considering the anticipated battery charge consumptions from the current SoC level of the battery due to both the battery's state and the driver's driving pattern.

Thereafter, the charging control system 1000 may determine whether the electric vehicle may reach the final destination with the battery (S330) based on the calculated drivable distance. In this case, the charging control system 1000 may determine that the electric vehicle cannot reach the final destination based on the current SoC level and the state information of the battery.

If it is determined that the electric vehicle cannot reach the final destination, the charging control system 1000 may display, on the user terminal of the electric vehicle, a recommended charging amount for enabling driving to the final destination from the chargeable capacity of the battery (S400). Step S400 is described later in further detail with reference to FIG. 9.

FIG. 9 depicts a detailed flowchart illustrating the step of displaying a recommended charging amount for the battery on the user terminal if it is determined that the electric vehicle cannot drive to its final destination based on the state of the battery, as performed in the method of FIG. 5.

That is, if it is determined that the electric vehicle cannot drive to the final destination based on the current state and performance of the battery, the charging control system 1000 may display data on the user terminal of the electric vehicle regarding the locations of charging stations between the current location of the electric vehicle and the final destination, as well as the charging amount that may be charged at each of the charging stations.

Referring to FIG. 9, the charging control system 1000 may recommend and present different charging amounts on the user terminal of the electric vehicle in consideration of the SoS of the battery, as determined in FIG. 7, only if there are no critical disqualifications for charging the battery.

First, the charging control system 1000 may determine whether the SoH of the battery exceeds a predetermined value (S410). As a result, the charging control system 1000 may not recommend a high SoC level for a battery that has already significantly aged.

Since the SoH of the battery may be affected by external temperatures, the charging control system 1000 may assign a greater weight value to indoor charging stations than to outdoor charging stations and may thereby vary the layout of recommended charging station candidates to be displayed.

If it is determined that the SoH of the battery exceeds the predetermined value (S410), the charging control system 1000 may lower the recommended charging amount for the battery, and at the same time, calculate an increase or decrease in the number of charging station stops needed for driving to the final destination (S450).

If it is determined that the number of charging station stops does not increase, the charging control system 1000 may not recommend a high SoC level (S470). For example, the charging control system 1000 may set the lowered recommended charging amount not to exceed 70% based on the battery's state.

As a result, the charging control system 1000 may recommend an appropriate charging amount that may ensure uniform battery performance or improve charging efficiency while reaching the final destination. Additionally, the charging control system 1000 may prevent unnecessary charging time consumption and accelerated battery aging that may result from the recommendation of a high charging amount.

Conversely, if it is determined that the number of charging station stops increases with the lowered recommended charging amount, the charging control system 1000 may determine whether the recommended charging station candidates include charging stations equipped with fast chargers (S460).

In this case, the recommended charging station candidates may vary depending on the recommended charging amount. For example, if it is determined that the electric vehicle needs to stop at more than two charging stations, a subsequent set of recommended charging station candidates may change based on the recommended charging amount for each station.

Therefore, if the charging station candidates include stations with fast chargers, the charging control system 1000 may not recommend an unnecessarily high SoC level for each charging station to stop at. However, if the charging station candidates do not include stations with fast chargers, the charging control system 1000 may display a high SoC level exceeding a predetermined value on the user terminal of the electric vehicle for driving to the final destination (S440).

If it is determined that the battery's condition is good because of the SoH of the battery not exceeding the predetermined value (S410), the charging control system 1000 may analyze the charging behavior of the battery using the charging history received in step S100. For example, if frequent overcharging of the battery is detected over a particular period, which may accelerate the aging of the battery, the charging control system 1000 may prevent the recommendation of a high SoC level in advance by analyzing the maximum charging amount (Max SoC) of the battery or the frequency of charging of the battery.

Accordingly, if the number of times the battery has been overcharged is greater than a predetermined value (S420), the charging control system 1000 may lower the recommended charging amount.

Conversely, if it is determined that both the SoH and charging behavior of the battery are both good, the charging control system 1000 may also determine whether the SoB of the battery exceeds a predetermined value (S430).

If it is determined that all the performance indicators of the battery are good, the charging control system 1000 may display a high SoC level on the user terminal of the electric vehicle as a recommended charging amount (S440). For example, the charging control system 1000 may display, on the user terminal of the electric vehicle, a recommended charging amount of about 80%, which is normally considered an optimal SoC level, along with the recommended charging station candidates between the current location and the final destination.

In an embodiment, the charging control system 1000 may reflect state information of the battery in real time when the electric vehicle is driving. Thus, charging station/charging amount data displayed on the user terminal of the electric vehicle by the charging control system 1000 may change depending on the location of the electric vehicle or monitoring result data regarding the state of the battery.

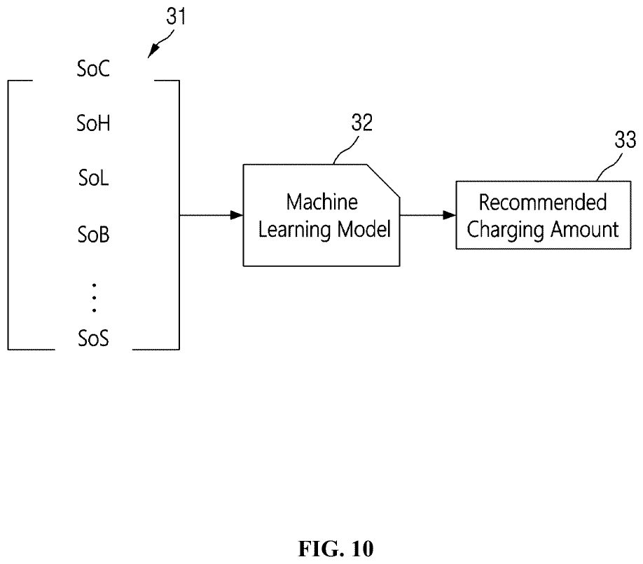

The method of controlling electric vehicle charging according to an embodiment of the present disclosure has been described so far with reference to FIGS. 5 through 9. A method of recommending a charging amount for a battery within an electric vehicle according to some embodiments of the present disclosure, which is implemented as a machine learning model, is hereinafter described with reference to FIG. 10.

FIG. 10 depicts a diagram illustrating a machine learning model outputting a recommended charging amount based on input state information of a battery, according to some embodiments of the present disclosure.

In an embodiment, the charging control system 1000 may replace the steps of monitoring the state of a battery and recommending a charging amount, i.e., steps S200 and S400 of FIG. 5, with a machine learning model 32.

Referring to FIG. 10, the charging control system 1000 may train the machine learning model 32 with data regarding the monitored state of the battery. For example, training data input to the machine learning model 32 may include data 31 on the SoC, SoH, SOL, SoB, and SoS of the battery.

Also, the charging control system 1000 may train the machine learning model 32 using data included in the driving information of the electric vehicle, such as charging scheduling data, driving pattern data, and internal/external battery data.

As a result, the charging control system 1000 does not need to acquire the driving information or monitor the state of the battery every time and may improve the speed and accuracy of recommendation of a charging amount for the battery, only using accumulated data.

In an embodiment, the step of determining the electric vehicle's feasibility of driving based on the acquired driving information or the monitored state of the battery, i.e., step S300 of FIG. 5, may also be replaced with the machine learning 32.

The application of a machine learning model to the process of recommending a charging amount for a battery has been described so far with reference to FIG. 10. State indicators for a battery according to some embodiments of the present disclosure is hereinafter described with reference to FIGS. 11 and 12.

FIGS. 11A and 11B depict diagrams illustrating the SoH of a battery, monitored according to some embodiments of the present disclosure.

Referring to FIG. 11A, the charging control system 1000 may identify that the SoH of a battery within an electric vehicle deteriorates as the charging/discharging cycles of the battery accumulate. In other words, as the charging/discharging cycles of the battery accumulate, the charging control system 1000 may detect a reduction in the chargeable capacity of the battery.

Also, referring to FIG. 11B, the charging control system 1000 may identify changes in the SoH of the battery based on external temperatures detected by external sensors of the electric vehicle. That is, the charging control system 1000 may determine that the SoH of the battery is influenced by the external temperature. In this case, the SoH of the battery may also fluctuate based on external impacts detected by the external sensors of the electric vehicle.

FIG. 12 is a diagram illustrating the SoS of a battery within an electric vehicle, described earlier with reference to FIGS. 6 to 7.

In some embodiments, the charging control system 1000 may monitor the SoS of the battery using three grades. For example, the SoS of the battery may be classified into one of three grades ranging from a highest-risk danger grade 51 to a caution grade 52 to a lowest-risk good grade 53. In this case, the charging control system 1000 may vary the level of risk displayed on the user terminal of the electric vehicle based on the SoS grade of the battery.

Furthermore, the charging control system may use various data from the electric vehicle's driving information or a plurality of battery state/performance indicators to differentiate between the grades for the SoS of the battery.

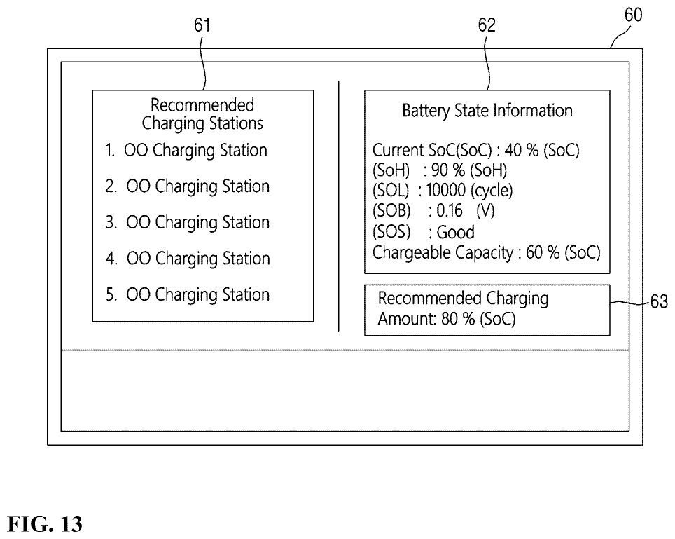

The state indicators for the monitored battery according to some embodiments of the present disclosure have been described so far with reference to FIGS. 11 to 12. The display of a recommended charging amount and recommended charging stations for a battery within an electric vehicle on the user terminal of the electric vehicle is hereinafter described with reference to FIG. 13.

FIG. 13 depicts a diagram illustrating a screen displaying a recommended charging amount and recommended charging stations according to some embodiments of the present disclosure.

Referring to FIG. 13, the charging control system may display data regarding a recommended charging amount 63 and recommended charging stations 61 for a battery within an electric vehicle on a user terminal 60 of the electric vehicle.

The charging control system may also display state information 62 of the battery on the user terminal 60 of the electric vehicle.

As a result, the charging control system may reduce the risk of accidents that may occur from a charged battery by enabling the driver of an electric vehicle to consider not only the current SoC level of the battery but also the state of the battery.

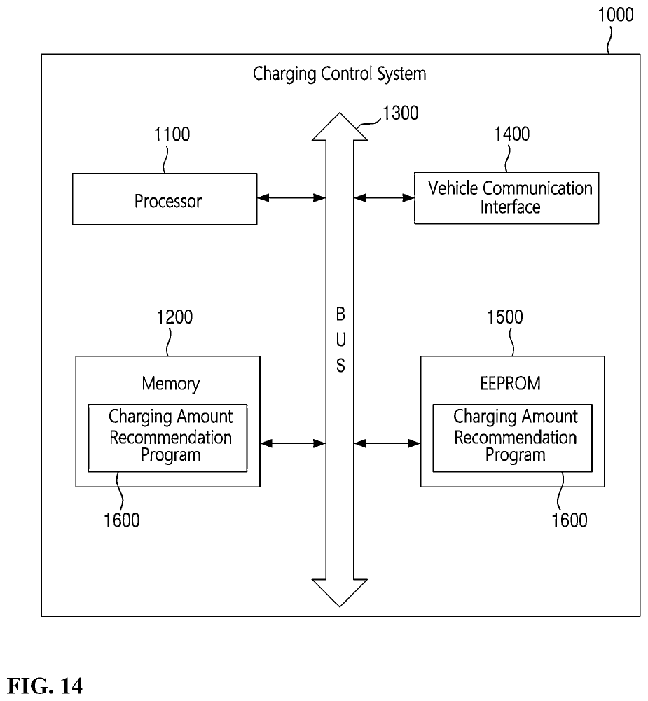

The outcomes of the method of controlling electric vehicle charging according to an embodiment of the present disclosure have been described so far with reference to FIG. 13. A case where the charging control system 1000, capable of implementing the method of controlling electric vehicle charging according to an embodiment of the present disclosure, may be combined with a computing device, is hereinafter described with reference to FIG. 14.

FIG. 14 depicts a hardware configuration view illustrating the charging control system 1000, implemented as a computing device.

Referring to FIG. 14, the charging control system 1000 may include at least one processor 1100, a bus 1300, a vehicle communication interface 1400, a memory 1200, which loads a charging amount recommendation program executed by the processor 1100, and an electrically erasable programmable read-only memory (EEPROM) 1500, which stores the charging amount recommendation program 1600. Only components related to embodiments of the present disclosure are illustrated in FIG. 14, and one having ordinary skill in the art to which the present disclosure pertains should recognize that other general components than those illustrated in FIG. 14 may also be included in the charging control system 1000.

Additionally, the charging control system 1000 may be configured without some of the components illustrated in FIG. 14. The components of the charging control system 1000 is hereinafter described.

The processor 1100 may control the overall operations of each component of the charging control system 1000. The processor 1100 may include at least one processor selected from among an electric vehicle communication controller (EVCC), an electronic control unit (ECU), a central processing unit (CPU), a micro-processor unit (MPU), a micro-controller unit (MCU), or any other form of processor known in the technical field of the present disclosure.

Furthermore, the processor 1100 may execute control over at least one controller or a vehicle communication network to execute operations/methods according to embodiments of the present disclosure. The charging control system 1000 may be equipped with one or more processors 1100.

The memory 1200 may store various data, commands, and/or information. The memory 1200 may load the charging amount recommendation program 1600 from the EEPROM 1500 to execute the operations/methods according to embodiments of the present disclosure.

The bus 1300 may provide communication functions between the components of the charging control system 1000. The bus 1300 may be implemented in various forms such as an address bus, data bus, and control bus.

The vehicle communication interface 1400 may support signal exchange between control devices and sensors within a vehicle. The vehicle communication interface 1400 may also support signal exchange among controllers within the vehicle. The vehicle communication interface 1400 may be configured to include a vehicle communication network technology such as a Controller Area Network (CAN), Local Interconnect Network (LIN), FlexRay, and vehicle Ethernet.

The EEPROM 1500 may non-transiently store the charging amount recommendation program 1600. The EEPROM 1500 may be replaced with a non-volatile memory such as a read-only memory (ROM), erasable programmable ROM (EPROM), flash memory, hard disk, removable disk, or any form of computer-readable recording medium known in the technical field of the present disclosure.

The charging amount recommendation program 1600 may contain one or more instructions that enable the processor 1100 to perform the operations/methods according to embodiments of the present disclosure when loaded into the memory 1200. That is, by executing the loaded instructions, the processor 1100 may perform the operations/methods according to embodiments of the present disclosure.

Various embodiments of the present disclosure and effects thereof have been described so far with reference to FIGS. 1 through 14. The effects according to the technical ideas of the present disclosure are not limited to those mentioned herein, and other unmentioned effects should be clearly understood by one having ordinary skill in the art from the following description.

The technical ideas described herein may be implemented as computer-readable code on a computer-readable medium. The computer program recorded on the computer-readable recording medium may be transmitted to other computing devices through a network such as the Internet and installed on the other computing devices, thereby being used on the other computing devices.

Although operations are shown in a specific order in the drawings, it should not be understood that desired results may be obtained when the operations must be performed in the specific order or sequential order or when all of the operations must be performed. In certain situations, multitasking and parallel processing may be advantageous. In concluding the detailed description, those having ordinary skill in the art should appreciate that many variations and modifications may be made to the preferred embodiments without substantially departing from the principles of the present disclosure. Therefore, the disclosed preferred embodiments of the disclosure are used in a generic and descriptive sense only and not for purposes of limitation.

The protection scope of the present invention should be interpreted by the following claims, and all technical ideas within the equivalent range should be interpreted as being included in the scope of the technical ideas defined by the present disclosure.

What is claimed is:

1. A charging control method performed by a charging control system, the method comprising:
receiving driving information of an electric vehicle;
monitoring a state of a battery within the electric vehicle;
determining the electric vehicle's feasibility of driving to a final destination; and
recommending, after it is determined that the electric vehicle is not feasible to drive to the final destination, a charging amount for the battery using the received driving information and the monitored state of the battery.

2. The charging control method of claim 1, wherein receiving the driving information comprises receiving at least one of charging scheduling data of the electric vehicle, driving pattern data of the electric vehicle, final destination data of the electric vehicle, or data detected by external sensors of the electric vehicle.

3. The charging control method of claim 1, wherein monitoring the state of the battery comprises determining a State of Health (SoH), a State of Life (SoL), a State of Balance (SoB), and a State of Safety (SoS) of the battery.

4. The charging control method of claim 3, wherein determining the SoH of the battery comprises determining a rate of decrease of a chargeable capacity of the battery using a charging scheduling data of the electric vehicle.

5. The charging control method of claim 3, wherein determining the SoH of the battery comprises determining a rate of decrease of a chargeable capacity of the battery using temperature data and/or impact data detected by external sensors of the electric vehicle.

6. The charging control method of claim 3, wherein determining the SOL of the battery comprises:
calculating a cycle where a chargeable capacity of the battery is reduced below a minimum standard SoC level; and
using a rate of decrease of the chargeable capacity of the battery.

7. The charging control method of claim 3, wherein determining the SoB of the battery comprises calculating, when the battery is a battery pack including a plurality of individual cells, differences between state indicators of the individual cells within the battery pack.

8. The charging control method of claim 3, wherein determining the SoS of the battery comprises classifying the SoS of the battery into grades, wherein the grades comprise good, caution, and danger grades.

9. The charging control method of claim 8, further comprising outputting a warning message to a communication controller of the electric vehicle when the SoS of the battery is classified as the caution grade.

10. The charging control method of claim 8, further comprising limiting the driving of the electric vehicle when the SoS of the battery is classified as the danger grade.

11. The charging control method of claim 1, wherein determining the electric vehicle's feasibility of driving to the final destination comprises:
calculating the electric vehicle's drivable distance based on the monitored state of the battery; and
determining the electric vehicle's feasibility of driving to the final destination based on the calculated drivable distance.

12. The charging control method of claim 11, wherein calculating the electric vehicle's drivable comprises:
updating state information of the battery using the electric vehicle's driving pattern; and
calculating the electric vehicle's drivable distance using the updated state information of the battery.

13. The charging control method of claim 1, wherein recommending the charging amount for the battery comprises displaying locations of charging stations that may be stopped at between a current location of the electric vehicle and the final destination.

14. The charging control method of claim 1, further comprising:
acquiring a machine learning model that has learned the monitored state of the battery; and
determining a charging amount to be recommended for the battery using the machine learning model.

15. A charging control apparatus comprising:
at least one processor;
a network interface configured to receive data regarding a battery included in a charging request signal from an electric vehicle;
a memory configured to store the received data;
a data collection unit configured to receive driving information of the electric vehicle;
a monitoring unit configured to monitor a state of the battery within the electric vehicle;
a determination unit configured to determine the electric vehicle's feasibility of driving to a final destination; and
a control unit configured to recommend a charging amount for the battery using the received driving information and the monitored state of the battery when it is determined that the electric vehicle is not feasible to drive to the final destination.

16. The charging control apparatus of claim 15, wherein the driving information includes at least one of charging scheduling data of the electric vehicle, driving pattern data of the electric vehicle, final destination data of the electric vehicle, or data detected by external sensors of the electric vehicle.

17. The charging control apparatus of claim 16, wherein the monitoring unit is configured to determine a State of Health (SoH), a State of Life (SoL), a State of Balance (SoB), and a State of Safety (SoS) of the battery.

18. A charging control system comprising:
a network interface configured to receive monitoring information regarding a battery within an electric vehicle;
a memory configured to load a charging amount recommendation program using the monitoring information regarding the battery; and
at least one processor configured to execute the charging amount recommendation program,
wherein the charging amount recommendation program includes instructions for receiving driving information of the electric vehicle, instructions for monitoring a state of the battery within the electric vehicle, instructions for determining the electric vehicle's feasibility of driving to a final destination, and instructions for recommending a charging amount for the battery using the received driving information and the monitored state of the battery when it is determined that the electric vehicle is not feasible to drive to the final destination.

19. The charging control system of claim 18, wherein the instructions for receiving the driving information include instructions for receiving at least one of charging scheduling data of the electric vehicle, driving pattern data of the electric vehicle, final destination data of the electric vehicle, or data detected by external sensors of the electric vehicle.

20. The charging control system of claim 18, wherein the instructions for monitoring the state of the battery include instructions for determining a State of Health (SoH), a State of Life (SoL), a State of Balance (SoB), and a State of Safety (SoS) of the battery.
